(19) United States
(12) Patent Application Publication
(10) Pub. No.: US 2026/0284857 A1
(43) Pub. Date: Sep. 24, 2026

(54) HOLDING BRACKET FOR POWER TOOL STAND

(71) Applicant: REXON INDUSTRIAL CORPORATION LTD., TAICHUNG CITY (TW)

(72) Inventors: YUE-YI LIN, TAICHUNG CITY (TW); SHAO-HUA LIN, TAICHUNG CITY (TW)

(21) Appl. No.: 19/188,450

(22) Filed: Apr. 24, 2025

(30) Foreign Application Priority Data
Mar. 18, 2025 (TW) 114110054

(51) Int. Cl. B25H 1/04; B25H 1/10

(52) U.S. Cl. CPC B25H 1/04; B25H 1/10

(57) ABSTRACT

A holding bracket for a power tool stand includes first and second positioning slots respectively provided at top and lateral sides thereof, and a plurality of position adjustment units each having a sliding member with an end portion extending through the second positioning slot, and a threaded fastener extending through the first positioning slot and being engaged with the sliding member, such that the position adjustment units are operable to move along the second positioning slot. Accordingly, when the holding bracket is assembled to a power tool stand, the position adjustment units can be adjusted according to the size of the power tool, allowing the holding bracket to secure power tools of various sizes.

### BACKGROUND OF THE INVENTION

### 1. Field of the Invention

The present invention relates to a holding bracket, and more particularly to a holding bracket for a power tool stand. By means of the structural design of the holding bracket, the distance between position adjustment units of the holding bracket can be flexibly adjusted, allowing power tools of various sizes to be securely fixed to the holding bracket.

### 2. Description of the Related Art

In woodworking operations, there is often a high demand for cutting tasks. Therefore, power tools such as miter saws or circular saw machines are used to assist in cutting wood materials, thereby improving cutting efficiency and accuracy. To facilitate portability and reduce storage space, foldable stands are commonly used to carry miter saws or circular saw machines. These stands provide an appropriate working height for woodworking tasks, enhancing operational convenience and efficiency. To support miter saws or circular saw machines of different specifications and to meet various operational requirements, such as height and width requirements, conventional stands are typically equipped with extendable workbenches to increase the working surface area. Additionally, the stands are usually equipped with wheels, facilitating movement of the stand, on which the power tool is mounted, directly to the desired working site.

CN Patent Publication No. 204414058 U discloses a foldable miter saw worktable, which includes a workbench and a stand. The workbench is formed by three transverse tubes fixed to one another, and the stand is arranged below the workbench. A mounting seat is disposed on the workbench, spanning across two of the transverse tubes and being fixed in place. The mounting seat is provided at a top side thereof with a plurality of positioning slots, into which a plurality of fixing members are inserted for securing the miter saw to the mounting seat. However, in this type of worktable, when installing the miter saw, screws must be inserted from openings at two ends of the mounting seat, and then tightened either by tools or fingers. Due to the narrow openings of the mounting seat, the space for tightening the screws is limited. The user must hold the nut outside the mounting seat with one hand while tightening the screw inside the mounting seat with the other, which makes the operation rather inconvenient. Furthermore, when installing a small-sized miter saw, the screws must be repositioned closer to the center of the mounting seat, making them even harder to reach and tighten.

Therefore, how to provide a stand for power tools, such as miter saws or circular saw machines, that facilitates easier installation and enhances the efficiency of securing the power tool is the goal pursued by the inventor.

### SUMMARY OF THE INVENTION

The present invention has been accomplished in view of the above-noted circumstances. It is an objective of the present invention to provide a holding bracket that facilitates the installation of power tools. The holding bracket is provided with slots at different positions to increase the operational range during installation of power tools, thereby making the installation process more convenient.

To achieve the above objective, the present invention provides a holding bracket for a power tool stand, which comprises at least one first positioning slot, at least one second positioning slot, and a plurality of position adjustment units. The first positioning slot is formed on a top side of the holding bracket. The second positioning slot is formed on a lateral side of the holding bracket. Each of the position adjustment units includes a sliding member and a threaded fastener. An end portion of the sliding member extends through the second positioning slot, and the threaded fastener extends through the first positioning slot and is engaged with the sliding member in a way that the position adjustment units are operable to move along the second positioning slot.

With the above-mentioned technical features, a user may install two holding brackets on a workbench of a power tool stand and reposition the position adjustment units thanks to the first and second positioning slots of the holding brackets. The sliding member of the position adjustment unit enables the threaded fastener to extend through the first positioning slot and directly engage with the sliding member. Therefore, the user does not need to use any tools or insert their fingers into the interior of the holding bracket to adjust the position adjustment units. Instead, the adjustment can be made conveniently from outside. Furthermore, by adjusting the positions of the position adjustment units, the relative distances among the position adjustment units can be changed, thereby facilitating installation of power tools of various sizes and allowing greater flexibility in tool selection.

Preferably, the power tool stand may comprise a base stand including a movable leg and a stationary leg pivotally connected with the movable leg. The moveable leg has one end pivotally connected with a bottom side of the workbench, and the other end, which is not connected with the workbench, provided with a wheel assembly. One end of the stationary leg is fixed to the bottom side of the workbench. Accordingly, the wheel assembly on the movable leg offers a convenient pulling function, and the moveable leg can pivotally move relative to the stationary leg, allowing the entire base stand to be folded and stored compactly, thereby making the power tool stand portable and less space occupation.

Preferably, the workbench comprises a slide frame including a plurality of slide tubes assembled together. As such, the slide frame constructed from hollow slide tubes can provide a support platform with sufficient strength and reduced weight.

Preferably, the workbench further includes at least one extension frame, which comprises an extension rod, a quick release disposed with the extension rod, a roller connected with the extension rod, and a stop plate connected with the extension rod. Accordingly, one end of a wooden workpiece may abut against the stop plate or rest on the roller to serve the purpose of fixation or conveyance, and the extension rod can extend outward from one end of the workbench to expand the working range, thereby accommodating wooden workpieces of different sizes.

Preferably, one end of the holding bracket is provided with a locking assembly, and a bottom side of the holding bracket is provided with a coupling portion for being engaged with the workbench. Two holding brackets may be used to be detachably assembled to the workbench by the locking assemblies. Accordingly, when the locking assemblies are locked, the holding brackets are clamped and fixed onto the workbench. When the locking assemblies are unlocked, the holding brackets can move along the workbench to adjust the distance between them according to the width of the power tool.

Preferably, one end of the second positioning slot of the holding bracket is enlarged to form a through hole. Accordingly, the through hole provides a larger opening that allows the sliding member of the position adjustment unit to pass therethrough and then to be placed into the interior of the holding bracket, thereby facilitating faster and more convenient installation of the sliding member.

Preferably, a stop block is optionally provided at the through hole in a way that the stop block is fastened to a sidewall of the holding bracket to block the through hole. As such, the stop block prevents the sliding member from moving into the through hole of the second positioning slot, thereby avoiding detachment of the sliding member from the second positioning slot during movement.

Preferably, the holding bracket includes an accommodation space that accommodates the position adjustment units. The accommodation space, the first positioning slot, and the second positioning slot are in communication with one another. Accordingly, when the position adjustment unit is used to secure a power tool, the sliding member can smoothly move along the second positioning slot to adjust its position, and the threaded fastener can then extend through the first positioning slot to be engaged with the sliding member.

Preferably, the sliding member comprises a retaining hole and a threaded portion. The retaining hole penetrates through a top surface and a bottom surface of the sliding member, and the threaded portion is provided at the top surface or the bottom surface of the sliding member, or directly formed around a wall of the retaining hole. Accordingly, the sliding member is directly provided with a threaded portion, allowing the threaded fastener to be directly secured to the sliding member through the first positioning slot of the holding bracket. This eliminates the need for the user to tighten or loosen the threaded fastener within the confined operational space of the holding bracket.

Preferably, the end portion of the sliding member is provided with a protruded gripping portion. Accordingly, the gripping portion provides a more comfortable gripping area, enabling the user to conveniently apply force to move the position adjustment unit.

The detailed structure, features, assembly, and usage of the holding bracket for a power tool stand provided by the present invention will be described in the following detailed embodiments. However, those skilled in the art will understand that such descriptions and specific embodiments are merely intended to illustrate the invention and are not to be construed as limiting the scope of the present patent application.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view showing that holding brackets provided by a preferred embodiment of the present invention are applied to a power tool stand and assembled with a power tool;

FIG. 2 is an exploded perspective view of FIG. 1;

FIG. 3 is a perspective view of the holding bracket of the preferred embodiment of the present invention;

FIG. 4 is an exploded perspective view of a position adjustment unit of the holding bracket of the preferred embodiment of the present invention;

FIG. 5 is a front view of the holding bracket of the preferred embodiment of the present invention, showing the position of the position adjustment unit;

FIG. 6 is a schematic front view, illustrating a state in which a power tool is to be assembled with the holding brackets of the preferred embodiment of the present invention;

FIG. 7 is a perspective view, showing a state in which the holding bracket and the stop block are separated; and

FIG. 8 is an exploded perspective view of a position adjustment unit of a holding bracket having a gripping portion according to another preferred embodiment of the present invention.

### DETAILED DESCRIPTION OF THE INVENTION

First of all, it is to be mentioned that same or similar reference numerals used in the following embodiments and the appendix drawings designate same or similar elements or the structural features thereof throughout the specification for the purpose of concise illustration of the present invention. It should be noticed that for the convenience of illustration, the components and the structure shown in the figures are not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements.

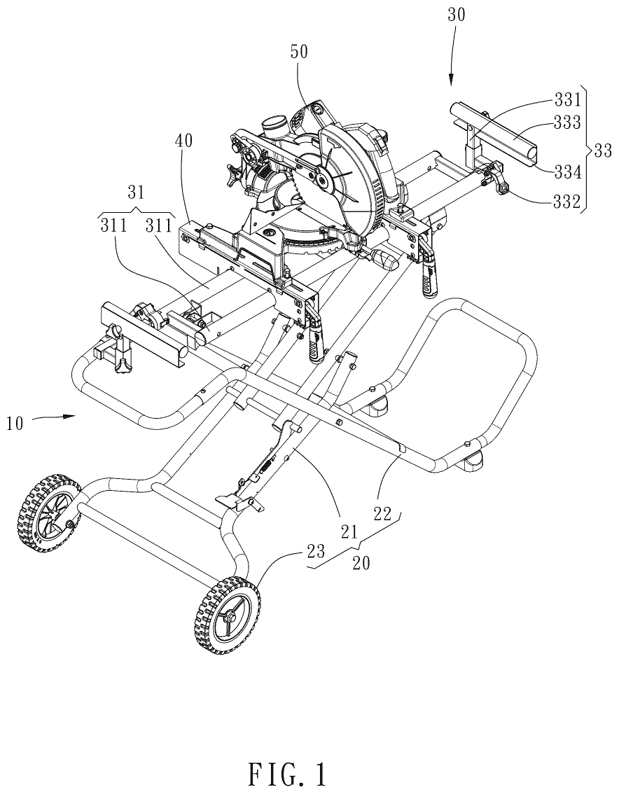

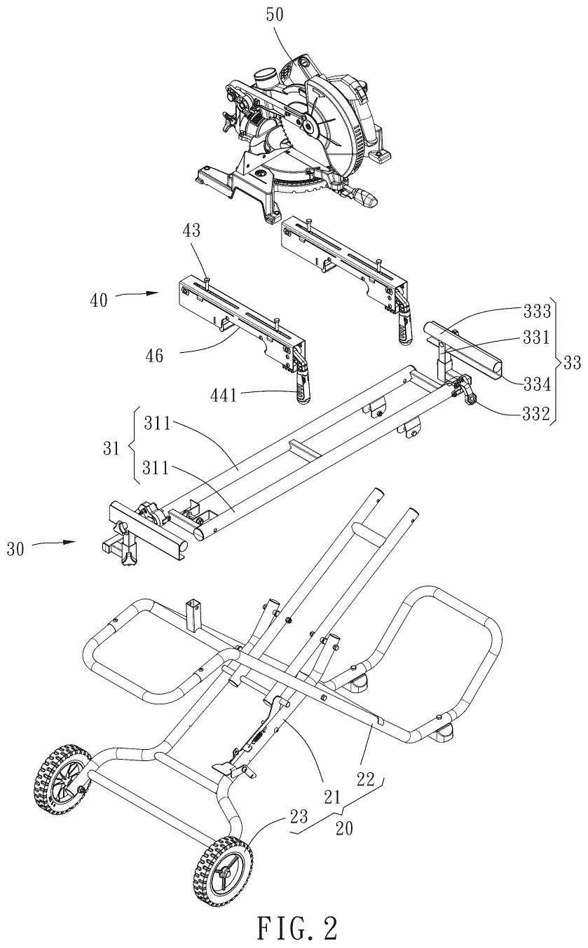

As shown in FIGS. 1 to 2, a power tool stand 10 according to a preferred embodiment of the present invention mainly comprises a base stand 20, a workbench 30, and two holding brackets 40. In the following embodiment, the power tool is exemplified using a miter saw 50.

The base stand 20 includes a movable leg 21 and a stationary leg 22. One end of the movable leg 21 is pivotally connected to a bottom side of the workbench 30, and one end of the stationary leg 22 is fixed to the bottom side of the workbench 30. A wheel assembly 23 is provided at the end of the movable leg 21 that is not connected to the workbench 30, allowing the base stand 20 to be moved via the wheel assembly 23. The central position of the stationary leg 22 is pivotally connected to a central position of the movable leg 21. The stationary leg 22 is wider than the movable leg 21, such that the moveable leg 21 is pivotally foldable relative to the stationary leg 22 for compact storage. In the stored state, the wheel assembly 23 touches the ground, and both the stationary leg 22 and the movable leg 21 stand almost vertically to the ground, with the workbench 30 positioned to the lateral side of the base stand 20. When the stationary leg 22 and the movable leg 21 are pivotally swung about their pivot connection, they form an X-shaped expanded configuration. At this time, the end of the stationary leg 22 that is not connected to the workbench 30 and the wheel assembly 23 contact the ground to support the workbench 30, allowing the holding brackets 40 on the workbench 30 to securely mount the miter saw 50 thereon.

The workbench 30 is disposed on a top side of the base stand 20 and includes a slide frame 31 and at least one extension frame 33. The slide frame 31 includes a plurality of slide tubes 311 arranged in parallel and assembled together to form a support platform. The extension frame 33 includes an extension rod 331, a quick release 332, a roller 333, and a stop plate 334. In this embodiment, two extension frames 33 are used, with each extension frame 33 disposed at one end of a slide tube 311. The extension rod 331 of the extension frame 33 may be composed of multiple rectangular tubes of different sizes. A longer rectangular tube is inserted into one end of the slide tube 311 and firmly connected with the slide tube 311 by means of the quick release 332. In this manner, after unlocking the quick release 332, the operating range can be adjusted by changing the depth to which the rectangular tube is inserted into the slide tube 311. The end of the longer rectangular tube of the extension rod 331 that is not inserted into the slide frame 31 is disposed with multiple shorter rectangular tubes. One of the short rectangular tubes is further disposed with the roller 333 and the stop plate 334. One end of a wooden workpiece can be positioned against the stop plate 334 to secure its position. For longer workpieces, they can be placed on the roller 333, which assists in feeding the material.

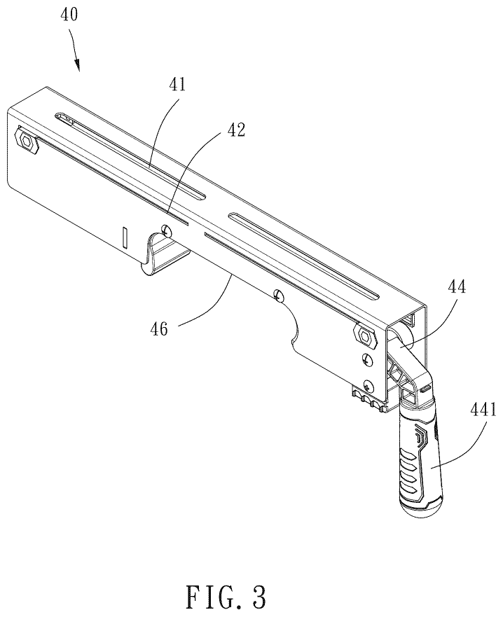

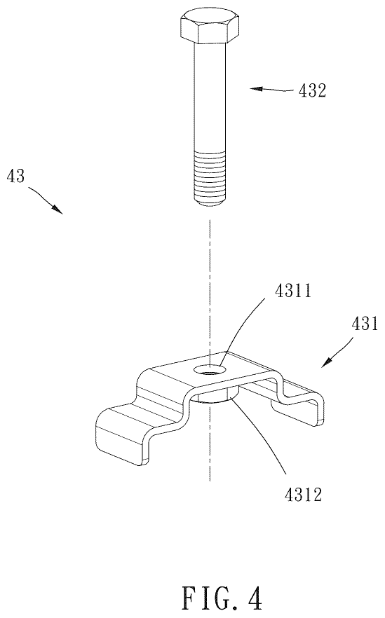

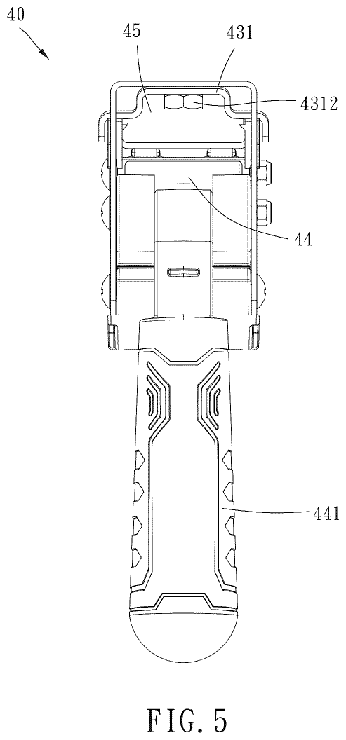

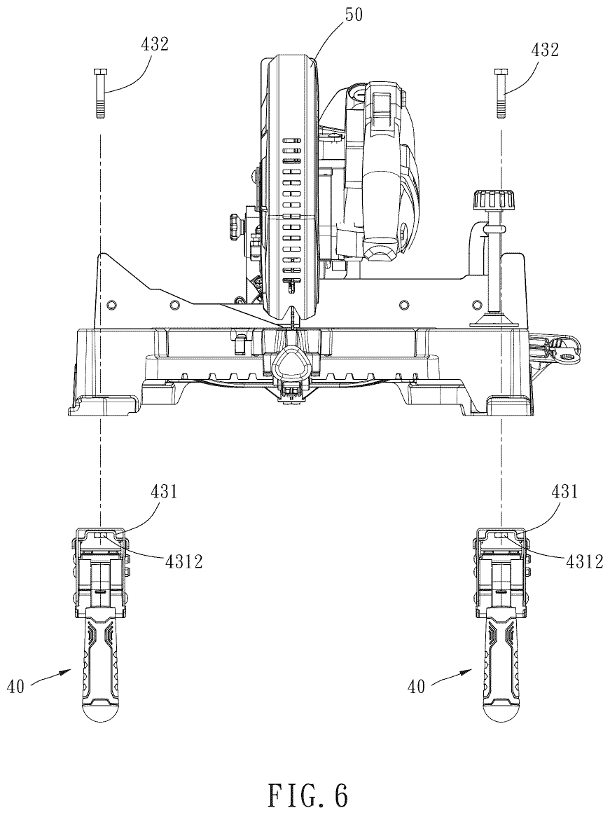

Referring to FIGS. 3 to 6, the holding bracket 40 includes at least one first positioning slot 41, at least one second positioning slot 42, a plurality of position adjustment units 43, and a locking assembly 44. The holding bracket 40 has a generally U-shaped hollow main body forming an accommodation space 45 inside, which communicates with both the first positioning slot 41 and the second positioning slot 42. The side of the U-shaped main body of the holding bracket 40 that provides the opening is defined as the bottom side, and a coupling portion 46 is formed by a recessed area of the bottom side. The holding bracket 40 spans across the slide frame 31 of the workbench 30 by means of the coupling portion 46, which is engaged with outer surfaces of the slide tubes 311 of the slide frame 31.

In this embodiment, two first positioning slots 41 are formed on a top side of the main body of the holding bracket 40, and two second positioning slots 42 are respectively formed on the left and right lateral sides of the main body of the holding bracket 40, for a total of four second positioning slots 42. However, the present invention is not limited to a specific number of first positioning slots 41 and second positioning slots 42 on one single holding bracket 40. It is also practicable to form one elongated first positioning slot 41 on the top side of one single holding bracket 40, and one elongated second positioning slot 42 on each of the left and right lateral sides of one single holding bracket 40. Alternatively, one elongated second positioning slot 42 may be formed on only one lateral side of the holding bracket 40.

The locking assembly 44 is provided at one end of the main body of the holding bracket 40 and controls the locking or unlocking state of the holding bracket 40 via a combination of a clamping member and a handle 441. The clamping member is accommodated in the accommodation space 45 inside the holding bracket 40 and partially exposed from the coupling portion 46. The handle 441 is connected to the clamping member and is exposed from an opening at one end of the holding bracket 40, allowing the user to operate the handle 441 to control the clamping member. By gripping the handle 441, the entire holding bracket 40 can be operated to be conveniently moved left or right along the slide tubes 311 of the slide frame 31, thereby adjusting the distance between two holding brackets 40.

Each position adjustment unit 43 includes a sliding member 431 and a threaded fastener 432. The threaded fastener 432 may be, for example, a bolt. The sliding member 431 is accommodated in the accommodation space 45 of the holding bracket 40, with both end portions extending through the second positioning slots 42 on opposite lateral sides. The end portions of the sliding member 431 extending through the second positioning slots 42 are bent downward to hold on the left and right sides of the holding bracket 40, so that the sliding member 431 will not easily escape when moving along the second positioning slots 42. The sliding member 431 further includes a retaining hole 4311 and a threaded portion 4312. The retaining hole 4311 penetrates through a top surface and a bottom surface of the sliding member 431. The threaded portion 4312 may be, for example, a nut welded to either the top or bottom surface of the sliding member 431. Alternatively, threads may be directly formed around the wall of the retaining hole 4311 so as to serve as the threaded portion 4312, allowing the threaded fastener 432 to be directly threaded into the threads around the wall of the retaining hole 4311 as soon as the threaded fastener 432 is inserted through the first positioning slot 41.

It is to be noted that if the holding bracket 40 is formed with only one second positioning slot 42, then only one end portion of the sliding member 431 will extend to a length sufficient to pass through the second positioning slot 42, while the other end portion will be shorter and housed within the accommodation space 45 inside the holding bracket 40.

To install the miter saw 50, the miter saw 50 is placed on the holding brackets 40. A typical miter saw 50 includes four locking points on its base. Therefore, in practice, four position adjustment units 43 are provided with two holding brackets 40, with two position adjustment units 43 arranged on each holding bracket 40. The user must move the position adjustment units 43 according to the locking points of the miter saw 50.

The user moves the sliding members 431 along the second positioning slot 42 by holding the two end portions of each sliding member 431. When the retaining holes 4311 of the four sliding members 431 are aligned with the locking points of the miter saw 50, the threaded fasteners 432 are inserted from top to bottom, first through the locking points of the miter saw 50, then through the first positioning slots 41 of the holding brackets 40, until they reach the positions of the retaining holes 4311 and the threaded portions 4312 of the sliding members 431. The threaded fasteners 432 can then be tightened. Since the threaded portion 4312 is directly integrated with the sliding member 431, and both end portions of the sliding member 431 extend from the second positioning slots 42, the user does not need to reach into the interior of the holding bracket 40 to hold the sliding member 431 while tightening or loosening the threaded fastener 432. Instead, the user can hold the sliding member 431 directly from the outside of the holding bracket 40. This makes the installation and positioning of the miter saw 50 much more convenient and efficient.

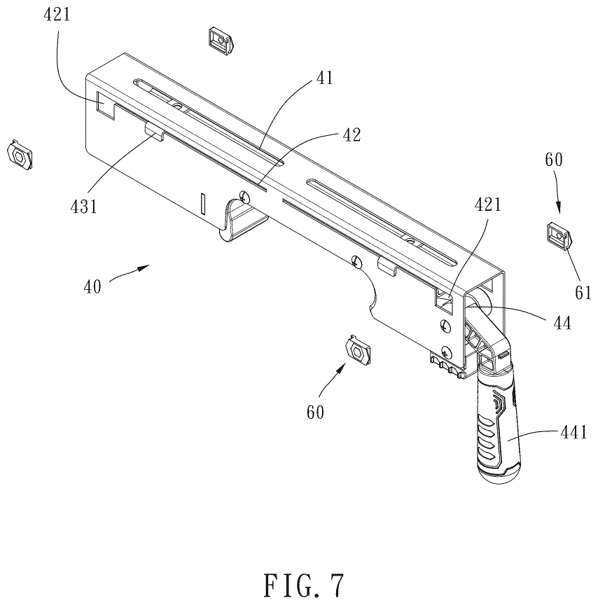

Referring to FIG. 7 again, one end of the second positioning slot 42 of the holding bracket 40 may, for example, be formed with a through hole 421, which is larger in dimension than the second positioning slot 42 and communicates with the second positioning slot 42. The through hole 421 allows the sliding member 431 of the position adjustment unit 43 to be directly inserted into the inside of the holding bracket 40, such that one end of the sliding member 431 can be easily coupled onto one lateral side of the holding bracket 40, and the other end can be then coupled onto the opposite lateral side of the holding bracket 40. The sliding member 431 can then be moved into the second positioning slot 42, enabling easy and quick installation of the sliding member 431.

However, to prevent the sliding member 431 from accidentally moving to the through hole 421 during use and detaching therefrom, a stop block 60 is provided in accordance with the shape of the through hole 421. After the sliding member 431 is assembled with the main body of the holding bracket 40, the stop block 60 is mounted at the location of the through hole 421. An engaging slit 61 is formed at the center of the stop block 60, allowing the stop block 60 to be clamped onto a sidewall of the holding bracket 40 via the engaging slit 61 and to cover and close the through hole 421. At this time, the remaining space of the through hole 421 is insufficient for the sliding member 431 to be removed, effectively preventing the sliding member 431 from detaching from the holding bracket 40.

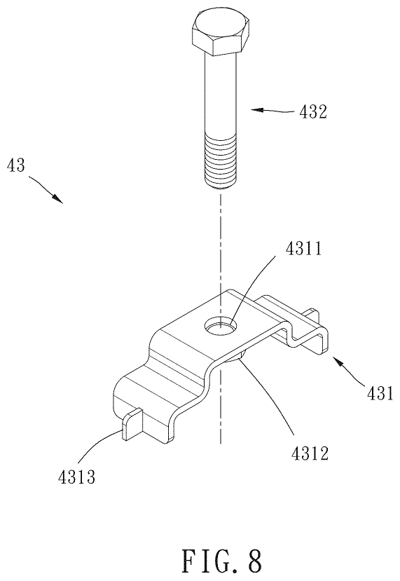

Referring to FIG. 8, to facilitate easier movement of the sliding member 431 of the position adjustment unit 43, the end portions at both ends of the sliding member 431 may, for example, protrude outward to form gripping portions 4313 or may be provided with lugs serving as the gripping portions 4313 by welding. This allows the user to hold one of the gripping portions 4313 with their fingers to move the sliding member 431, or to use two fingers to span the top side of the holding bracket 40 and push against both gripping portions 4313 at the ends of the sliding member 431, thereby moving the sliding member 431 by pushing. This enables the user to adjust the sliding member 431 of the position adjustment unit 43 in a comfortable and effortless manner.

In summary, compared with the prior art, the holding bracket 40 for a power tool stand 10 provided by the present invention offers at least the following advantages:
1. The holding bracket 40 of the present invention utilizes the design of the second positioning slot 42 to allow the user to easily move the sliding member 431 of the position adjustment unit 43 to an appropriate position according to the size of the miter saw 50, and then fix the miter saw 50 via the first positioning slot 41, thereby achieving the advantage of rapid positioning.
2. In the holding bracket 40 of the present invention, the threaded fastener 432 can be directly engaged with the sliding member 431, and both end portions of the sliding member 431 extend through the second positioning slots 42 of the holding bracket 40. In this way, when installing the miter saw 50, the user does not need to insert tools or fingers into the narrow space within the holding bracket 40. Instead, the user can hold the sliding member 431 from the outside of the holding bracket 40, such that the threaded fastener 432 can be easily aligned with the sliding member 431 to fix the miter saw 50, thereby making the installation process of the power tool more convenient.

At last, it should be mentioned again that the constituent elements disclosed in the above embodiments of the present invention are only taken as examples for illustration, not intended to limit the scope of the present invention. The substitution or variation of other equivalent elements should be included within the scope of the following claims of the present invention.

What is claimed is:

1. A holding bracket for a power tool stand, the power tool stand comprising a base stand and a workbench disposed on the base stand, the holding bracket being adapted for being assembled with the workbench, the holding bracket comprising:
at least one first positioning slot formed on a top side of the holding bracket;
at least one second positioning slot formed on a lateral side of the holding bracket; and
a plurality of position adjustment units each including a sliding member having at least one end portion extending through the second positioning slot, and a threaded fastener extending through the first positioning slot and being engaged with the sliding member in a way that the position adjustment units are operable to move along the second positioning slot.

2. The holding bracket of claim 1, wherein the base stand comprises a movable leg and a stationary leg pivotally connected with the movable leg; the movable leg has one end pivotally connected with a bottom side of the workbench, and the other end, which is not connected with the workbench, provided with a wheel assembly; one end of the stationary leg is fixed to the bottom side of the workbench.

3. The holding bracket of claim 1, wherein the workbench comprises a slide frame including a plurality of slide tubes assembled together.

4. The holding bracket of claim 1, wherein the workbench comprises at least one extension frame each including an extension rod, a quick release disposed with the extension rod, a roller connected with the extension rod, and a stop plate connected with the extension rod.

5. The holding bracket of claim 1, wherein the holding bracket is provided at an end thereof with a locking assembly, and at a bottom side thereof with a coupling portion for being engaged with the workbench; the holding bracket is detachably engaged with the workbench by the locking assembly.

6. The holding bracket of claim 1, wherein one end of the second positioning slot is enlarged to form a through hole.

7. The holding bracket of claim 6, wherein a stop block is engageable with the through hole in a way that the stop block is fastened to a sidewall of the holding bracket to close the through hole.

8. The holding bracket of claim 1, comprising an accommodation space accommodating the position adjustment unit; the accommodation space, the first positioning slot, and the second positioning slot are in communication with one another.

9. The holding bracket of claim 1, wherein the sliding member comprises a retaining hole and a threaded portion; the retaining hole penetrates through a top surface and a bottom surface of the sliding member; the threaded portion is provided at the top surface or the bottom surface of the sliding member, or directly formed around a wall of the retaining hole of the sliding member.

10. The holding bracket of claim 1, wherein the end portion of the sliding member is provided with a protruded gripping portion.
